(19) United States
(12) Patent Application Publication
(10) Pub. No.: US 2018/0024535 A1
(43) Pub. Date: Jan. 25, 2018

(54) SYSTEM AND METHOD FOR DYNAMICALLY REPORTING MANUFACTURING DATA IN A SPREADSHEET FORMAT

(71) Applicant: FreePoint Technologies Inc., London (CA)

(72) Inventors: Paul HOGENDOORN, London (CA); Sophear NET, London (CA)

(21) Appl. No.: 15/707,140

(22) Filed: Sep. 18, 2017

Related U.S. Application Data
(63) Continuation of application No. 14/468,559, filed on Aug. 26, 2014.
(60) Provisional application No. 61/870,342, filed on Aug. 27, 2013.

(51) Int. Cl. G05B 19/418

(52) U.S. Cl. CPC G05B 19/4183; G05B 2219/31288; G05B 2219/31318; Y02P 90/10

(57) ABSTRACT

An illustrative example system for monitoring a plurality of events in a manufacturing facility includes a plurality of monitoring devices. Each of the monitoring devices obtains data regarding a selected one of the events. A reporting device receives the data obtained by the monitoring devices and provides a report regarding the monitored events. The report includes information regarding at least one characteristic of each of the monitored events. The information in the report is dynamically updated to provide a real time indication of the characteristics of the monitored events. The real time indications are presented in respective cells of the report.

### CROSS REFERENCE TO RELATED APPLICATION

This application is a continuation of U.S. patent application Ser. No. 14/468,559, filed on Aug. 26, 2014, which claims priority to U.S. Patent Application Ser. No. 61/870,342, filed on Aug. 27, 2013.

### BACKGROUND

Manufacturing typically involves a sequence of events or processes. An error, shortfall or problem with any of those events or processes may have ripple effects that compromise overall product quality or reliability.

Attempts at identifying potential issues during manufacturing have been made but they have not provided a way in which issues can be identified in a timely or accurate enough manner. For example, it has been proposed to collect manufacturing data from a machine that has been designed with appropriate sensors or provided with such sensors. Even with such data collection there is a delay between potential issue identification and reporting as the sensor data typically must go from the sensor to a programmable logic controller, to a router, and then through some sort of network server before that data is processed and eventually reported in a way that does not make the potential issue or its source readily apparent. Reporting techniques may include data aggregation and analytics programs. In many instances if the data is provided to those responsible for machine operation or process completion at all it is well after the process or event at issue occurred.

Another challenge to manufacturers may be that the equipment used for various manufacturing processes or events can vary significantly in technological sophistication and age. Older machines and manual processes do not usually have sensors or diagnostic equipment associated with them. On the other hand more modern equipment may have some diagnostic equipment or sensors already in place. It is difficult to gather information from such varied equipment in an efficient and useful manner using known techniques. Further some such equipment may require modifications to the control features and that presents a cost and time barrier that may inhibit attempts to gather information from such machinery.

### SUMMARY

An illustrative example system for monitoring a plurality of events in a manufacturing facility includes a plurality of monitoring devices. Each of the monitoring devices obtains data regarding a selected one of the events. A reporting device receives the data obtained by the monitoring devices and provides a report regarding the monitored events. The report includes information regarding at least one characteristic of each of the monitored events. The information in the report is dynamically updated to provide a real time indication of the characteristics of the monitored events. The real time indications are presented in respective cells of the report including a first set of the cells that provides at least one indication of a machine or equipment involved in at least one of the monitored events, a second set of the cells that provides an indication of a status of a machine or equipment having an indication in the first set of the cells, a third set of the cells that provides an indication of a total run time for a machine or equipment having an indication in the first set of cells, and a fourth set of the cells that provides an indication of a number of cycles performed by a machine or equipment having an indication in the first set of cells.

An illustrative example method of monitoring a plurality of events in a manufacturing facility includes obtaining data regarding the events from monitoring devices, communicating the obtained data to a reporting device, and providing a report regarding the monitored events. The report includes information regarding at least one characteristic of each of the monitored events. The example method includes dynamically updating the information of the report to provide a real time indication of the characteristics of the monitored events, and presenting the real time indications in respective cells of the report.

Various features and advantages of at least one example disclosed system and method will become apparent to those skilled in the art from the following detailed description. The drawings that accompany that description can be briefly described as follows.

### BRIEF DESCRIPTION OF THE DRAWINGS

FIG. 1 schematically illustrates a system for monitoring and reporting manufacturing data designed according to an embodiment of this invention.

FIG. 2 illustrates an example report format used in an example embodiment of this invention.

FIG. 3 illustrates an example monitoring device according to an embodiment of this invention.

FIG. 4 schematically illustrates one example version of the example monitoring device of FIG. 3.

FIG. 5 schematically illustrates another example version of the example monitoring device of FIG. 3.

FIG. 6 is a flow chart diagram summarizing an example method of monitoring and reporting manufacturing data.

### DETAILED DESCRIPTION

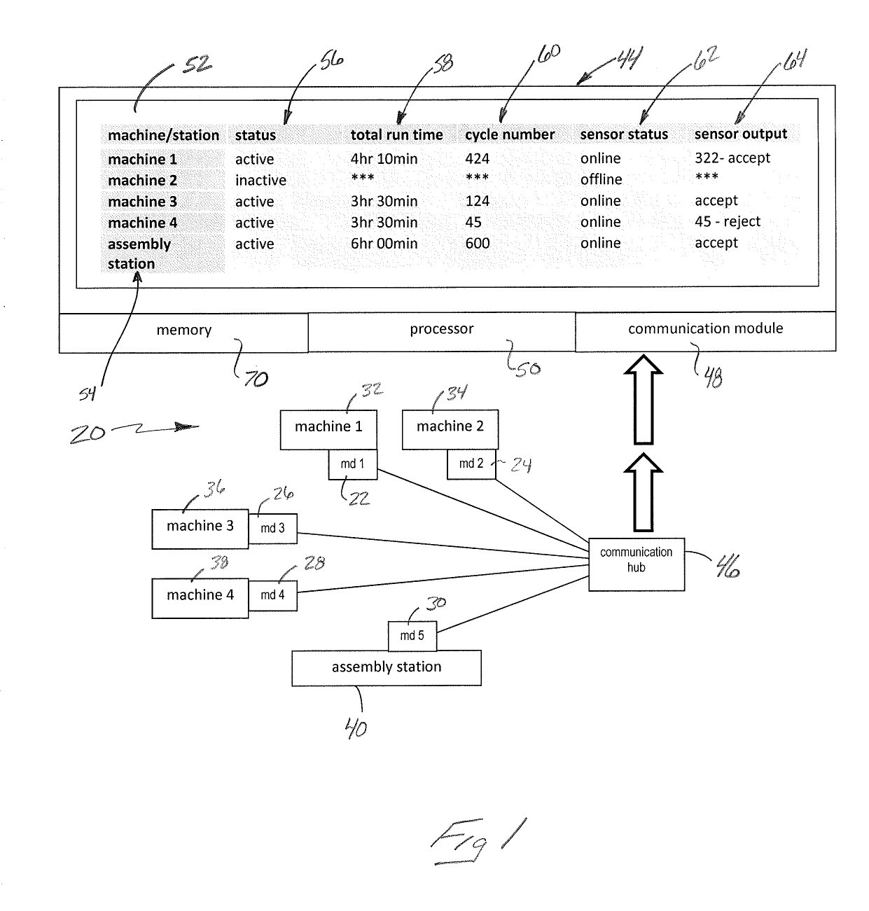

FIG. 1 schematically illustrates an example system 20 that is useful for monitoring and reporting manufacturing data within a facility that includes a variety of equipment. A plurality of monitoring devices 22-30 (md1-md5) are provided for monitoring a corresponding plurality of events or processes that occur during manufacturing. It should be noted that the term manufacturing is used in this description in a rather generic sense and should not be strictly construed. Example techniques that may be considered manufacturing for purposes of discussion include making, molding, forming, cutting, assembling, or securing operations.

The monitoring devices respectively obtain information for a selected one of the events or processes. In the illustrated example, each monitoring device 22-30 is associated with a particular machine or a particular portion of the equipment used during manufacturing. The monitoring devices 22, 24, 26 and 28 are respectively associated with machines 32, 34, 36 and 38. The machines 32-28 are at least partially automated and complete at least one process or cause at least one event to happen in an automated fashion. The corresponding monitoring devices obtain information regarding the automatic operation of those machines or at least selected portions of those machines. The monitoring device 30 is associated with a manual assembly station 40 that at least one operator uses to perform a manual task or operation.

The monitoring devices provide information to a reporting device 44 that provides a report regarding the various processes or events occurring at the different machines. In this example the monitoring devices 22-30 communicate with the reporting device 44 through a communication hub 46 while in other examples, one or more of the monitoring devices 22-30 communicates directly with the reporting device 44. The communications schematically shown in FIG. 1 may be accomplished using wired (e.g., serial or Ethernet) or wireless links (e.g., WiFi, Xbee or Bluetooth), depending on the configuration of the devices in a particular embodiment and the needs of a particular situation.

The monitoring devices 22-30 obtain information directly from the machines 22-38 or the assembly station 40, respectively, or a sensor or other device associated with the corresponding machine or station. Example sensors can include proximity sensors, limit switches, and foot pedal switches. The information is indicative of a selected feature or characteristic of at least one event or process that is part of the manufacturing process of interest. There are a variety of known parameters that can be used, for example, to monitor the quality or output of a machine used in manufacturing or assembly processes. The monitoring devices 22-30 gather such information to provide an indication of the progress of one or more operations being completed by or at the machines 32-38 or the station 40.

The data obtained by the monitoring devices 22-30 is used by the reporting device to provide dynamically updated indications regarding the characteristic or feature of a process or event based on current conditions in the manufacturing facility. In the example of FIG. 1, the reporting device includes a communication module 48 configured for receiving the data obtained by the monitoring devices 22-30. A processor 50 is programmed to interpret the obtained data and relate it to a particular portion of a report so that meaningful information is available to a machine operator or facility manager, for example. The example reporting device has (or communicates with) a display 52 that provides a visual representation of the report.

In this example, the output on the display 54 is in a spread sheet format that contains indications within various cells of the spread sheet and the information in each cell is updated in real time to reflect the current conditions at the manufacturing facility. The report as output on the display 52 provides a dynamic, changing representation of the conditions of interest for monitoring the progress and conditions at the manufacturing facility.

The information in the report provided by the reporting device 44 may take a variety of forms. The illustrated example includes information such as, the status of a machine (e.g., active or on), an elapsed or total monitoring period (i.e., total run time), a number of cycles, a cycle number, a sensor status and a sensor output. Other possible information includes a number of processed items, a number of deviations from an expected performance, a number of times a particular user definable input has changed, an area under a curve that describes a portion of an associated process or part, or an interval timer to report how long the user definable input has been in the current state.

In the example of FIG. 1 the report includes a first column of cells at 54 that provide an indication of the machine or equipment. A second column of cells 56 provides an indication of the status of the corresponding machine or equipment. A third column of cells 58 provides an indication of a total run time for each machine or the equipment identified in the corresponding row of cells. The cells in the column 60 include an indication of the number of cycles performed. The cells in the columns 62 and 64 respectively include indications of a sensor status and the current (or most recently obtained) output of the corresponding sensor.

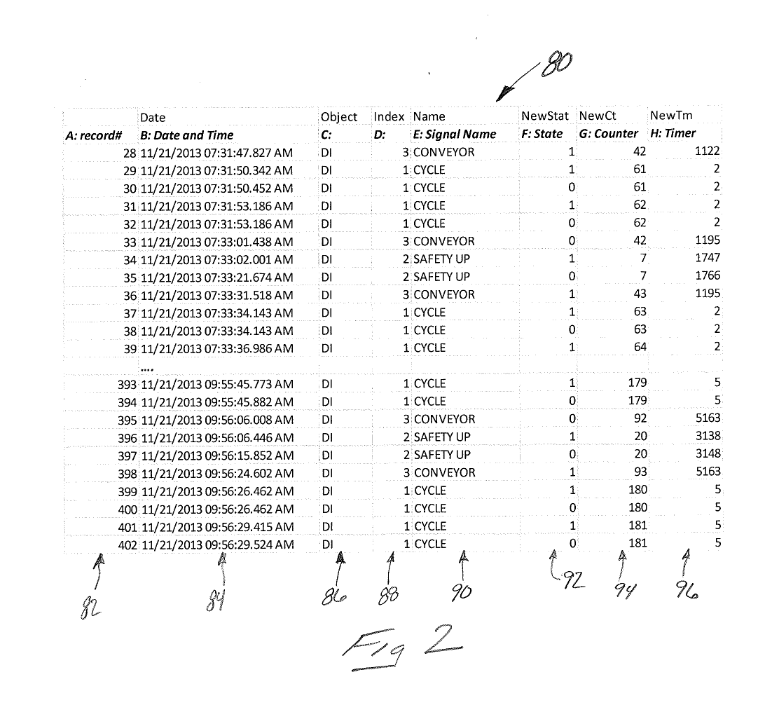

The example reporting device includes a memory 70 that is configured to at least temporarily retain information regarding the data obtained by the monitoring devices 22-30. The information in the memory allows for analysis of monitored manufacturing processes or events over time to identify trends or commonality among different issues associated with various manufacturing practices. FIG. 2 schematically illustrates a report 80 that makes all of the reported indications previously reported in a dynamic, real-time fashion on the display 52, for example, available for further analysis. The ability to view all aspects of a manufacturing run at a facility from the information in the memory 70 in a manner as shown in FIG. 2 increases the possible analyses that are facilitated by the example system 20. The report of FIG. 2 may be made available in real time with additional rows of information added to the report as manufacturing progresses.

In the example report 80 of FIG. 2, the column 82 includes a sequential event or record number. The cells in the column 84 include indications of the time each event occurred. The column 86 indicates what type of event occurred (in this case, ‘DI’ is used to indicate a digital input). The cells in the column 88 indicate which specific input experienced a condition change at the corresponding time indicated in the same row in the column 84. The input signal has been given a name in the indications shown in column 90 so that an operator, technician, or manager may more readily determine the event, process or equipment involved. The cells in the column 92 indicate the new state of the input (e.g., ‘0’=off, ‘1’=on). Column 94 indicates the number of times the associated input has changed state. The indications in the column 96 show how much accumulated time the signal has been in the ‘true’ (‘on’ or ‘active’) state.

In the illustrated example, 328 events have occurred between 7:31:47 AM (record number 28) and 9:56:29 AM (record number 402). For illustration clarity purposes, record numbers 40 to 392 have been suppressed. Reporting the production data obtained by the monitoring devices in spreadsheet form provides the ability to use available tools and functions built into available spreadsheet programs. For example, although not expressly stated in FIG. 2, the reported indications and information makes it possible to determine the total parts produced, the total time (in seconds) selected equipment was running, the total time any of the machines was in set-up or adjustment time, the total number of times the safety cover needed to be opened, and the total production period. As events occur on the machines or processes being monitored, the timers and counter information is automatically updated and transferred into the spreadsheet format report as described above. The preceding examples illustrate how the functions built into standard spreadsheet programs can be used to derive meaningful productivity information from manufacturing processes in real-time or on an as-needed basis.

FIG. 3 shows one example embodiment of a monitoring device 22. This example includes a housing 100 that has a base that facilitates mounting the monitoring device 22 in a strategic location relative to a machine, component or facility. A connector 102 is configured to couple a sensor or detector with the device 22 or to couple an appropriate portion of a machine or equipment with the device 22, depending on the particular embodiment.

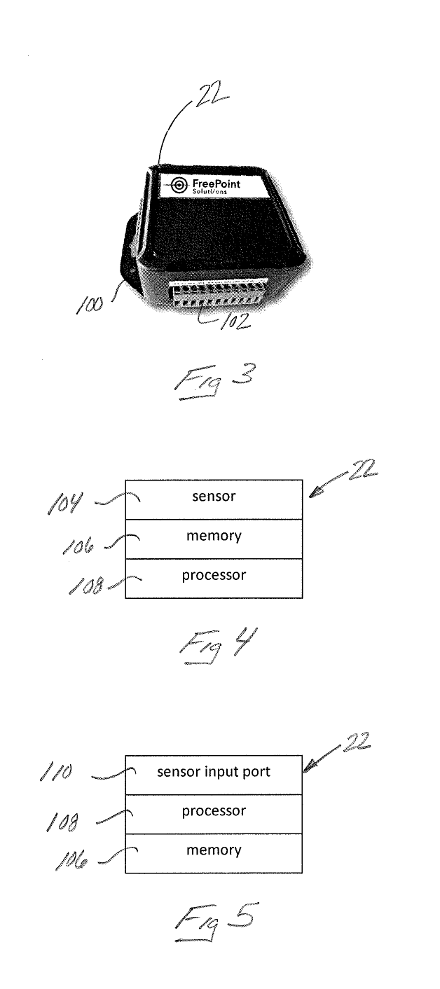

FIG. 4 shows one version of the monitoring device 22 which includes a sensor 104, a memory 106 and a processor 108. The sensor 104 allows the monitoring device 22 to obtain information from equipment that does not otherwise have a sensor for detecting one or more characteristics of a process or event. The processor 106 and memory or data storage 108 are configured to allow the monitoring device 22 to provide the information as it is presented in the spread sheet format report discussed above. In some examples, the monitoring devices 22 provide raw data or information to the reporting device 44 and the processor 50 determines the appropriate output information and provides the information to be included in the report.

This example includes user definable inputs or unique instructions embedded into the memory 106 or directly into the processor 108. The monitoring device 22 may automatically collect selected productivity data based on the user defined inputs. The user definable inputs may be digital or analog. One feature of this embodiment is that different monitoring devices may be customized to meet the particular needs of a given facility so that meaningful information may be obtained regarding a variety of manufacturing processes or events without requiring any modification to the manufacturing equipment.

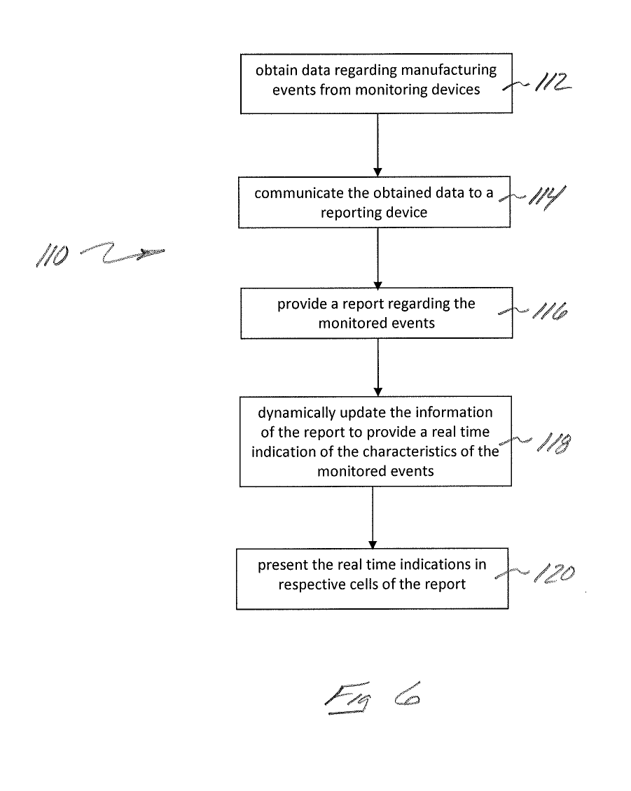

The example of FIG. 5 does not include its own sensor but, instead, has a sensor input port 110 configured for receiving data from a sensor associated with the equipment of interest.

In some examples a utility program in the monitoring device 22 is configured for interpreting productivity data. The utility program allows the monitoring device 22 to determine the reported information in corresponding cells of the output and to update the reported information in real time. If a change of state is detected executing the utility program results in a new entry into a database and a corresponding change in the appropriate cell of the output. The device executing the utility program records information about the event that included the change in the data to the extent such information may be captured by the monitoring device 22.

The utility program may also be configured in the processor 50 and memory 70 of the reporting device 44. Regardless of which device or combination of devices hosts the utility program it is configured so that the indications in the cells of the spread sheet report output are automatically and dynamically updated based on information reported by at least a corresponding one of the monitoring devices 22-30. With the example system 20 it is possible to connect directly with sensors or equipment without affecting any existing control system and without requiring any modification to the equipment or sensor. A real-time, dynamically updated output providing indications of various manufacturing processes or events is available with the illustrated example regardless of the age, brand or model of the machine or manufacturing equipment at a facility.

FIG. 6 is a flow chart diagram 110 that summarize an example approach of using a system such as that shown in FIG. 1. In this example, the method includes obtaining data at 112 regarding manufacturing events from the monitoring devices 22-30. At 114 the obtained data is communicated to the reporting device 44. A report regarding the monitored events is provided at 116. The information of the report is dynamically updated at 118 in real time to provide indications of the characteristics of the monitored events. The real time indications are provided in respective cells of a spread sheet format report at 120.

The preceding description is illustrative rather than limiting in nature. An example system and method are disclosed that provide enhanced abilities to monitor manufacturing processes and equipment. Variations and modifications to the disclosed examples may become apparent to those skilled in the art. Such changes do not necessarily depart from the essence of this invention. The scope of legal protection provided to this invention can only be determined from the following claims.

We claim:

1. A system for monitoring a plurality of events in a manufacturing facility, the system comprising:
a plurality of monitoring devices, each of the monitoring devices obtains data regarding a selected one of the events; and
a reporting device that receives the data obtained by the monitoring devices and provides a report regarding the monitored events, the report including information regarding at least one characteristic of each of the monitored events, the information in the report being dynamically updated to provide a real time indication of the characteristics of the monitored events, the real time indications being presented in respective cells of the report, wherein:
a first set of the cells provides at least one indication of a machine or equipment involved in at least one of the monitored events,
a second set of the cells provides an indication of a status of a machine or equipment having an indication in the first set of the cells,
a third set of the cells provides an indication of a total run time for a machine or equipment having an indication in the first set of cells,
a fourth set of the cells provides an indication of a number of cycles performed by a machine or equipment having an indication in the first set of cells,
at least one of the monitoring devices includes a housing mounted in a selected location relative to a selected machine,
the at least one of the monitoring devices includes a memory and a processor in the housing,
the at least one of the monitoring devices includes a plurality of user-defined inputs embedded in the memory or the processor,
the user-defined inputs configure the at least one of the monitoring devices to obtain selected information regarding operation of the selected machine,
the at least one of the monitoring devices providing a real-time, dynamically updated output to an individual machine operator of the selected machine regarding current operation of the selected machine.

2. The system of claim 1, wherein
the reporting device includes a display; and
the report is visually perceivable on the display.

3. The system of claim 1, wherein the reporting device provides the report in a spreadsheet format.

4. The system of claim 1, wherein the reporting device includes a memory portion that contains a record of the indications of the report over time.

5. The system of claim 1, wherein
at least one of the monitoring devices is configured to obtain the data from a sensor that is configured to provide information regarding the corresponding selected one of the events.

6. The system of claim 1, wherein
at least one of the monitoring devices comprises a sensor configured to obtain the data regarding the corresponding selected one of the events.

7. The system of claim 1, wherein at least one of the monitoring devices comprises
a processor for interpreting the data and providing the information to be included in the report; and
a memory portion for at least temporarily retaining the data obtained by the at least one of the monitoring devices.

8. The system of claim 1, wherein the monitoring devices communicate with the reporting device.

9. The system of claim 1, comprising
a communication hub that receives data from the monitoring devices and communicates the received data to the reporting device.

10. A method of monitoring a plurality of events in a manufacturing facility, the method comprising the steps of:
obtaining data regarding the events from monitoring devices;
communicating the obtained data to a reporting device;
providing a report regarding the monitored events, the report including information regarding at least one characteristic of each of the monitored events;
dynamically updating the information of the report to provide a real time indication of the characteristics of the monitored events;
presenting the real time indications in respective cells of the report; and
using at least one of the reporting device or one of the monitoring devices to provide a real-time, dynamically updated output to an individual machine operator of a selected machine regarding current operation of the selected machine, wherein:
the real-time, dynamically updated output comprises a plurality of cells,
a first set of the cells provides at least one indication of a machine or equipment involved in at least one of the monitored events,
a second set of the cells provides an indication of a status of a machine or equipment having an indication in the first set of the cells,
a third set of the cells provides an indication of a total run time for a machine or equipment having an indication in the first set of cells,
a fourth set of the cells provides an indication of a number of cycles performed by a machine or equipment having an indication in the first set of cells,
the at least one of the monitoring devices includes a housing mounted in a selected location relative to the selected machine,
the at least one of the monitoring devices includes a memory and a processor in the housing,
the at least one of the monitoring devices includes a plurality of user-defined inputs embedded in the memory or the processor, and
the user-defined inputs configure the at least one of the monitoring devices to obtain selected information regarding operation of the selected machine.

11. The method of claim 10, comprising
displaying the report in a visually perceivable format on a display.

12. The method of claim 10, comprising providing the report in a spreadsheet format.

13. The method of claim 10, comprising maintaining a record of the indications of the report over time in a memory associated with the reporting device.

14. The method of claim 10, comprising communicating the data from the monitoring devices to the reporting device.

15. The method of claim 10, comprising
communicating the data from the monitoring devices to a communication hub; and
communicating at least one of the data or the report information from the communication hub to the reporting device.

16. The method of claim 10, comprising providing the real-time, dynamically updated output to the machine operator on a display screen.

17. A manufacturing machine, comprising:
a machine portion that is configured to at least partially complete at least one manufacturing process in an automated fashion; and
at least one monitoring device including a housing mounted in a selected location relative to the machine portion, the at least one monitoring device including a memory and a processor in the housing, the at least one monitoring device including a plurality of user-defined inputs embedded in the memory or the processor, the user-defined inputs configuring the at least one monitoring device to obtain selected information regarding operation of the machine portion while completing the at least one process; and
a reporting device that receives the selected information obtained by the monitoring devices,
wherein:
at least one of the reporting device and the at least one monitoring device provides a real-time, dynamically updated output to an individual machine operator of the machine regarding current operation of the selected machine,
the real-time, dynamically updated output comprises a plurality of cells,
a first set of the cells provides at least one indication of a machine or equipment involved in at least one of the monitored events,
a second set of the cells provides an indication of a status of a machine or equipment having an indication in the first set of the cells,
a third set of the cells provides an indication of a total run time for a machine or equipment having an indication in the first set of cells, and
a fourth set of the cells provides an indication of a number of cycles performed by a machine or equipment having an indication in the first set of cells.

18. The machine of claim 17, comprising a display screen associated with the reporting device, the display screen providing the real-time, dynamically updated output to the machine operator.
